(19) United States
(12) Patent Application Publication
(10) Pub. No.: US 2013/0292937 A1
(43) Pub. Date: Nov. 7, 2013

(54) U-BEND FITTING

(71) Applicant: PHOENIX GEOTHERMAL SERVICES, LLC, Auburn, NY (US)

(72) Inventors: John Douglas Manning, Auburn, NY (US); Jared Paul Fortna, Ithaca, NY (US); Mitchell Louis Conklin, Moravia, NY (US); Ron Abraham Gershoni, San Diego, CA (US); Danny Gershoni, Closter, NJ (US)

(73) Assignee: Phoenix Geothermal Services, LLC, Auburn, NY (US)

(21) Appl. No.: 13/886,707

(22) Filed: May 3, 2013

Related U.S. Application Data
(60) Provisional application No. 61/643,099, filed on May 4, 2012.

(51) Int. Cl. F16L 43/00

(52) U.S. Cl. CPC F16L 43/00
USPC 285/134.1

(57) ABSTRACT

A U-bend fitting having a flow path chamber and a flow transition chamber is disclosed. In one embodiment, the U-bend fitting is designed with its maximum outer diameter to be substantially equal to the maximum combined outer diameter of the pipes which are fused to the flow path chamber. The flow transition chamber is designed to provide a larger flow path between the two pipes without any sharp turns.

### CROSS-REFERENCE TO RELATED APPLICATIONS (IF NECESSARY)

This application claims the benefit of and priority to U.S. Provisional Patent Application Ser. No. 61/643,099, filed May 4, 2012, and entitled “U-BEND FITTING,” the entirety of which is incorporated herein by reference.

### BACKGROUND OF THE INVENTION

The subject matter disclosed herein relates to U-bend fittings in flow systems, including fittings used in geothermal systems.

Ground source heat pump systems include ground loops (horizontal or vertical) that utilize pipes (e.g., High Density Polyethylene (“HDPE”) pipes) to exchange heat with the ground. These pipes extend from a header buried near the earth's surface or in a mechanical room to the bottom of a vertical borehole or the end of a horizontal trench and return to the header via the same borehole or trench. At the bottom of each vertical borehole or at the end of each horizontal trench (when straight lengths of pipe are used), the return and supply piping are connected by a 180-degree U-bend fitting, which allows an anti-freeze solution to circulate throughout the piping loop. Typically, piping manufacturers fuse this U-bend fitting to their pipe coil and then sell the piping to distributors, well drillers, and contractors. Once a pipe loop is pushed into a hole, an expensive mixture of thermally enhanced grout and sand is pumped down the hole to fill all open spaces, thereby increasing heat transfer.

One existing U-bend fitting design is a single molded fitting that allows for a full 180-degree turn. Another existing U-bend fitting design is one spigot and one socket 90-degree elbow that are fused together to create the 180-degree turn. These existing U-bend fitting designs have features that result in additional costs for ground loops. For example, since the outside diameter of the U-bend fitting is significantly larger than the maximum combined outer diameter of the two pipes (supply and return) pressed together, when drilling a borehole, the driller must use a larger diameter drill bit and create a larger diameter hole specifically to accommodate the larger outer diameter of the U-bend fitting. For example, although the maximum combined outer diameter of two 1.25 in. (31.75 mm) pipes pressed together may be approximately 3.32 in. (84.33 mm), the outer diameter of the U-bend may be over 4.0 in. (101.6 mm), requiring a borehole with a diameter large enough to accommodate the U-bend and much larger than the outer diameter of the pipes. Since larger diameter boreholes usually take more time to drill, this increases labor costs. These larger diameter boreholes also require larger drill rigs that can increase the likelihood of damaging existing property and create accessibility issues. In addition, since boreholes are typically hundreds of feet in length, the empty space from the surface to the bottom of the borehole that exists between the pipes themselves and between the pipes and the walls of the borehole must be backfilled with thermally enhanced grout and sand, increasing costs and labor. These larger diameter boreholes also increase the costs of transportation to remove the excavated material from the borehole.

The existing U-bend fitting designs also include relatively sharp turns and significantly tapered interiors, resulting in relatively small flow areas. For example, while the flow area for a 1.25 in. (31.75 mm) diameter pipe is 1.45 sq. in. (9.35 sq. cm), the flow area for a typical 1.25 in. (31.75 mm) diameter pipe is 0.93 sq. in. (6.00 sq. cm). This smaller, reduced flow area can force a significant decrease in the flow rate of the circulating anti-freeze solution as it travels through the U-bend fitting. This pressure drop introduced by the U-bend fitting requires significantly more pumping power and associated electricity costs to maintain the working pressure in the system. In addition, the smaller flow area can increase the risk that debris that inadvertently enters the ground loops of the heat pump system can block the flow.

The existing U-bend fitting designs are generally manufactured to be fused with smaller diameter pipes (0.75 in. (19.05 mm), 1.0 in. (25.4 mm), 1.25 in. (31.75 mm)) Although certain pipe loops in deeper boreholes extending several hundred feet can be more efficient when using larger diameter pipe loops (e.g., 1.5 in. (38.1), 2.0 in. (50.8 mm)), those pipe loops are sometimes not used since standard U-bend fittings to accommodate those larger diameter pipe loops may not be available and would require fabrication of more expensive custom U-bend fittings.

The discussion above is merely provided for general background information and is not intended to be used as an aid in determining the scope of the claimed subject matter.

### BRIEF DESCRIPTION OF THE INVENTION

A U-bend fitting having a flow path chamber and a flow transition chamber is disclosed. In one embodiment, the U-bend fitting is designed with its maximum outer diameter to be substantially equal to the maximum combined outer diameter of the pipes which are fused to the flow path chamber. The flow transition chamber is designed to provide a larger flow path between the two pipes without any sharp turns.

An advantage that may be realized in the practice of some disclosed embodiments of the U-bend fitting is that the diameter of the borehole can be much smaller, resulting in a less expensive and easier to construct smaller diameter borehole than used with a conventional U-bend fitting. In addition, the larger flow path without any sharp turns can provide a smaller pressure drop than a conventional U-bend fitting, requiring less pumping power and resulting in energy savings. Also, the larger flow area can decrease the risk that debris that inadvertently enters the ground loops of the heat pump system can block the flow.

In one embodiment, a U-bend fitting is disclosed for connecting a first pipe having a first pipe outer diameter and a second pipe having a second pipe outer diameter, wherein the first pipe extends parallel to the second pipe. The U-bend fitting comprises a flow path chamber comprising a housing extending longitudinally from a first end of the flow path chamber to a second end of the flow path chamber, a flow path chamber pipe interface comprising a first pipe interface located at the first end of the flow path chamber for connecting the first pipe to the flow path chamber and a second pipe interface located at the first end of the flow path chamber for connecting the second pipe to the flow path chamber, and a divider wall disposed within the housing, the divider wall extending transversally across the inside of the housing and extending longitudinally from a first end at a location between the first pipe interface and the second pipe interface to a second end toward the second end of the flow path chamber, wherein the divider wall divides the flow path chamber into a first flow path extending longitudinally through the flow path chamber from the first pipe interface and a second flow path extending longitudinally through the flow path chamber from the second pipe interface. The U-bend fitting also comprises and a flow transition chamber comprising a cap connected to and enclosing the second end of the flow path chamber, and a hemispherical cavity formed on the inner surface of the cap to provide a flow transition path between the first flow path and the second flow path.

In another embodiment, a U-bend fitting is disclosed for connecting a first pipe having a first pipe outer diameter, a second pipe having a second pipe outer diameter, a third pipe having a third pipe outer diameter, and a fourth pipe having a fourth pipe outer diameter, wherein the pipes extend parallel to each other. The U-bend fitting comprises a flow path chamber comprising a housing extending longitudinally from a first end of the flow path chamber to a second end of the flow path chamber, a flow path chamber pipe interface comprising a first pipe interface located at the first end of the flow path chamber for connecting the first pipe to the flow path chamber, a second pipe interface located at the first end of the flow path chamber for connecting the second pipe to the flow path chamber, a third pipe interface located at the first end of the flow path chamber for connecting the third pipe to the flow path chamber, and a fourth pipe interface located at the first end of the flow path chamber for connecting the fourth pipe to the flow path chamber, a first divider wall disposed within the housing, the divider wall extending transversally across the inside of the housing and extending longitudinally from a first end at a location between the first pipe interface and the second pipe interface to a second end toward the second end of the flow path chamber, a second divider wall disposed within the housing, the divider wall extending transversally across the inside of the housing and extending longitudinally from a first end at a location between the third pipe interface and the fourth pipe interface to a second end toward the second end of the flow path chamber, a third divider wall disposed within the housing, the divider wall extending transversally across the inside of the housing and extending longitudinally from a first end at a location between first pipe interface and the third pipe interface to a second end toward the second end of the flow path chamber, and a fourth divider wall disposed within the housing, the divider wall extending transversally across the inside of the housing and extending longitudinally from a first end at a location between the second pipe interface and the fourth pipe interface to a second end toward the second end of the flow path chamber, wherein the divider walls divide the flow path chamber into a first flow path extending longitudinally through the flow path chamber from the first pipe interface, a second flow path extending longitudinally through the flow path chamber from the second pipe interface, a third flow path extending longitudinally through the flow path chamber from the third pipe interface, and a fourth flow path extending longitudinally through the flow path chamber from the fourth pipe interface. The U-bend fitting also comprises a flow transition chamber comprising a cap connected to and enclosing the second end of the flow path chamber, and a hemispherical cavity formed on the inner surface of the cap to provide a flow transition path between the first flow path and one or more of the second, third, and fourth flow paths.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is perspective view of an exemplary U-bend fitting for two pipes showing a flow path chamber fused to a flow transition chamber;

FIG. 2 is a front view of the exemplary U-bend fitting of FIG. 1;

FIG. 3 is a side view of the exemplary U-bend fitting of FIG. 1;

FIG. 4 is a top view of the exemplary U-bend fitting of FIG. 1;

FIG. 5 is a bottom view of the exemplary U-bend fitting of FIG. 1;

FIG. 6 is a cross-section of the exemplary U-bend fitting of FIG. 1 shown fused to two pipes;

FIG. 7 is perspective top view of the flow path chamber of the exemplary U-bend fitting of FIG. 1;

FIG. 8 is a perspective bottom view of the flow path chamber of the exemplary U-bend fitting of FIG. 1;

FIG. 9 is a cross-section (side view) of the flow path chamber of FIGS. 7 and 8;

FIG. 10 is a perspective top view of the flow transition chamber of the exemplary U-bend fitting of FIG. 1;

FIG. 11 is perspective side view of the flow transition chamber of the exemplary U-bend fitting of FIG. 1;

FIG. 12 is a side view of the flow transition chamber of FIGS. 10 and 11;

FIG. 13 is perspective side view of an exemplary U-bend fitting for four pipes showing a flow path chamber fused to a flow transition chamber;

FIG. 14 is perspective top view of the flow path chamber of the exemplary U-bend fitting of FIG. 13; and

FIG. 15 is a perspective bottom view of the flow path chamber of the exemplary U-bend fitting of FIG. 13;

While the exemplary U-bend fitting is shown in the figures to interface with 1.25 in. (31.75 mm) diameter pipes, it will be understood that the same or similar U-bend fitting design with different dimension scan be used for pipes of different diameters (e.g., 0.75 in. (19.05 mm), 1.0 in. (25.4 mm), 1.5 in. (38.1 mm), 2.0 in. (50.8 mm), etc.).

### DESCRIPTION OF THE INVENTION

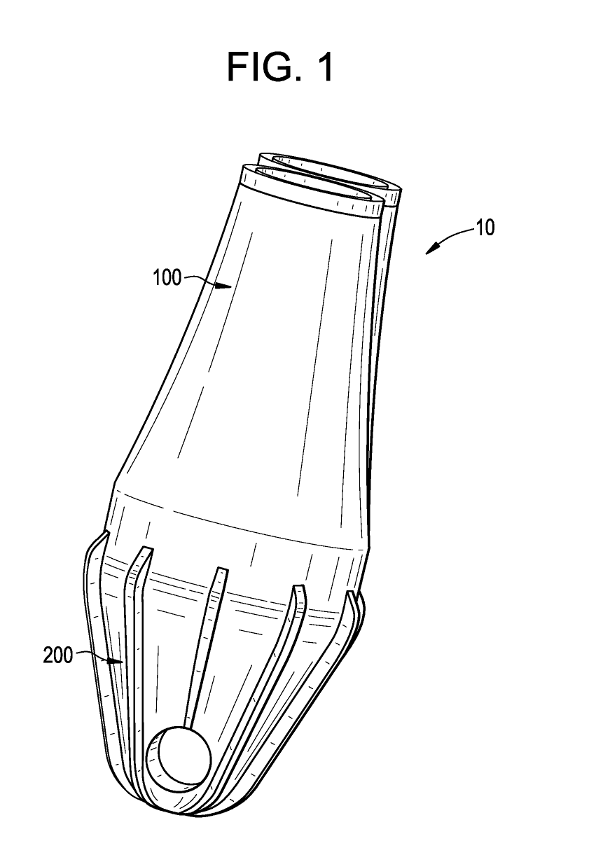

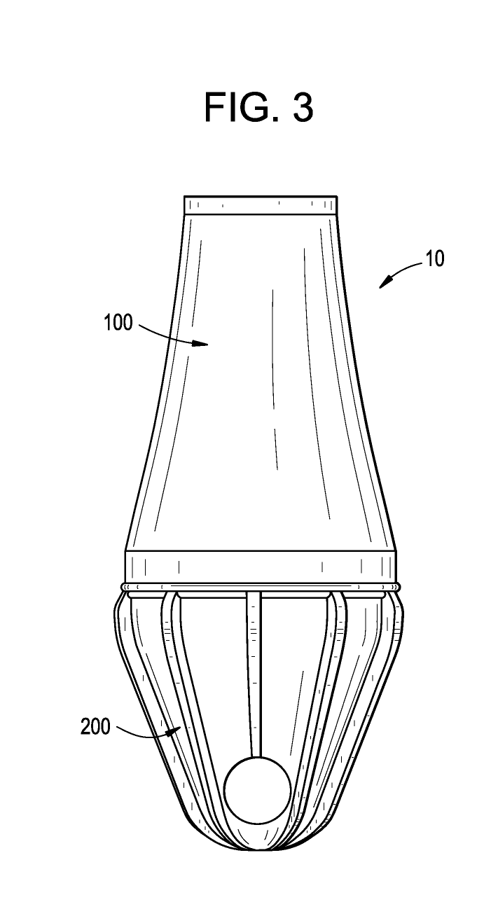

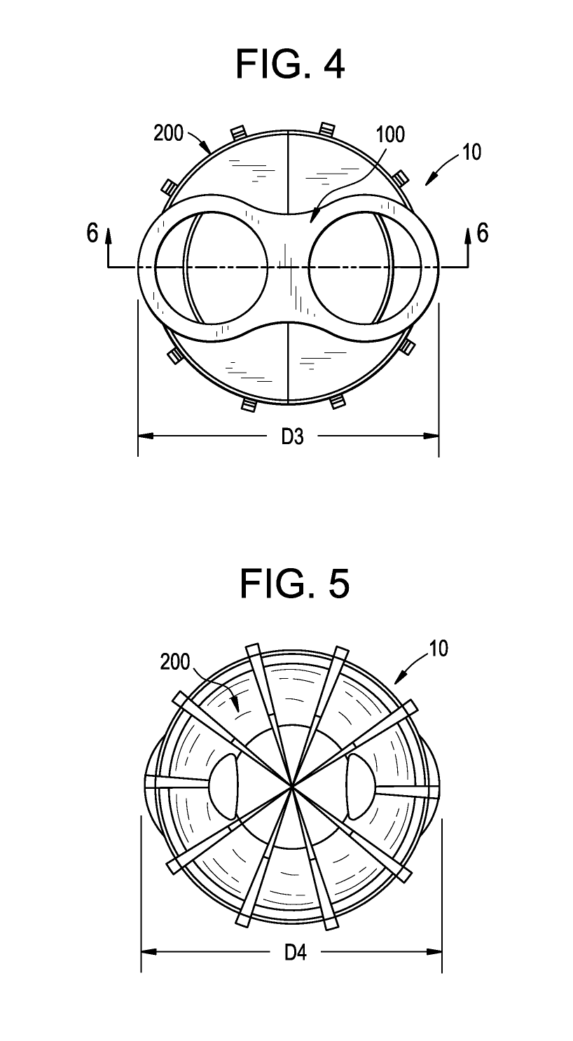

FIGS. 1-5 are perspective, front, side, top, and bottom views of an exemplary U-bend fitting 10 showing a flow path chamber 100 fused to a flow transition chamber 200. In one embodiment, the U-bend fitting 10 is manufactured from PE100/PE4710 resin, which is compatible with PE3408, PE3608, PE4710, and PE100 pipe typically used ground source heat pump systems pipe. In one embodiment, a textured surface can be molded on the U-bend fitting 10 to provide friction for a better grip while fusing in the field. This texture gives the surface of the U-bend fitting 10 a uniform, consistent look, rather than a non-uniform swirl inherent in all other injection molded HDPE and particularly PE100. In one embodiment, the flow path chamber 100 can be fused to the flow transition chamber 200 using butt fusion. It will be understood that other materials, textures, and attachment techniques can be used in the manufacture and assembly of the U-bend fitting.

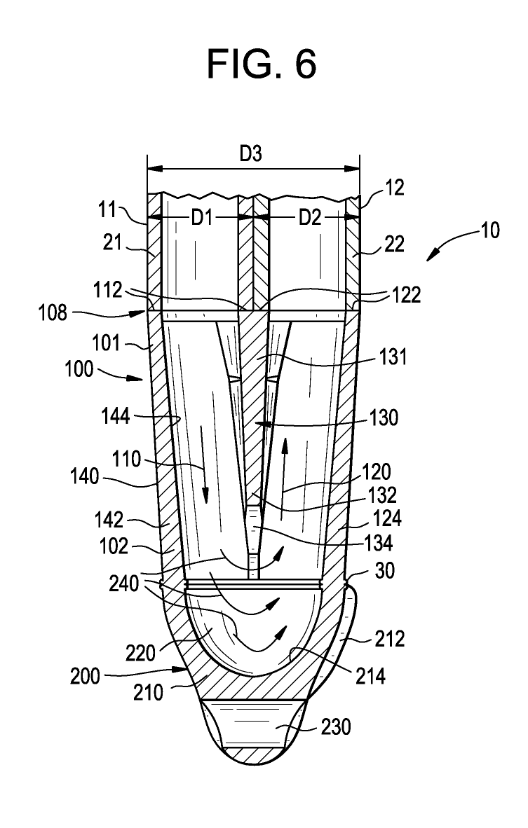

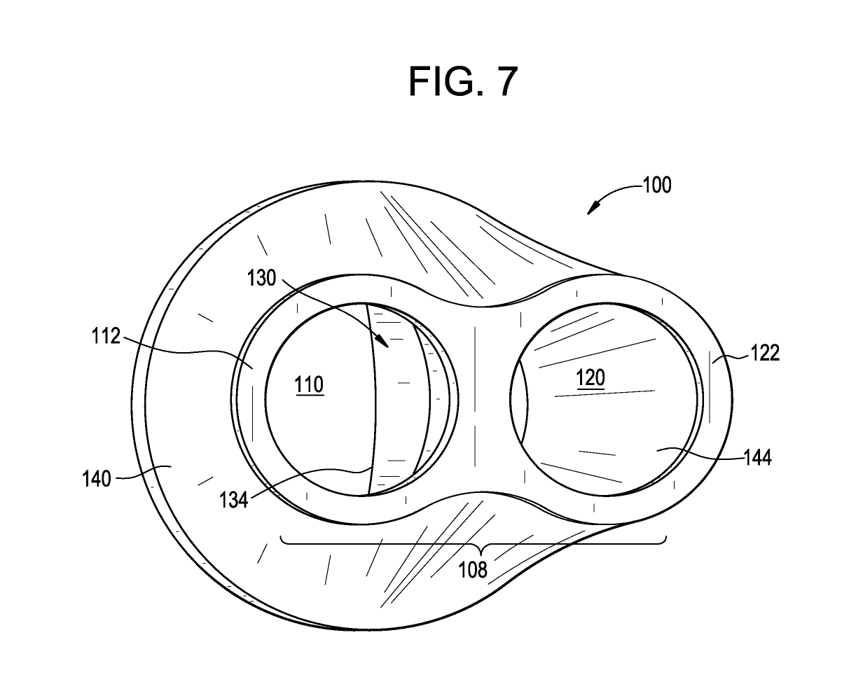

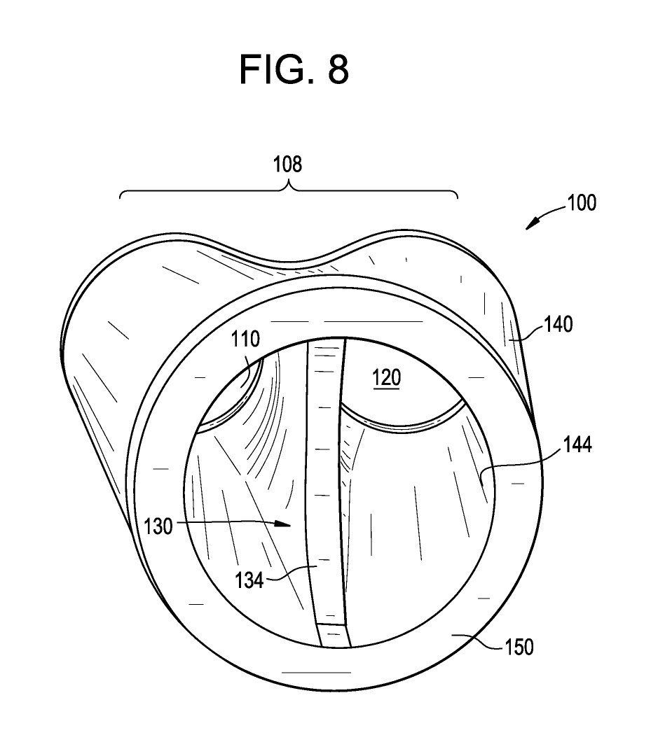

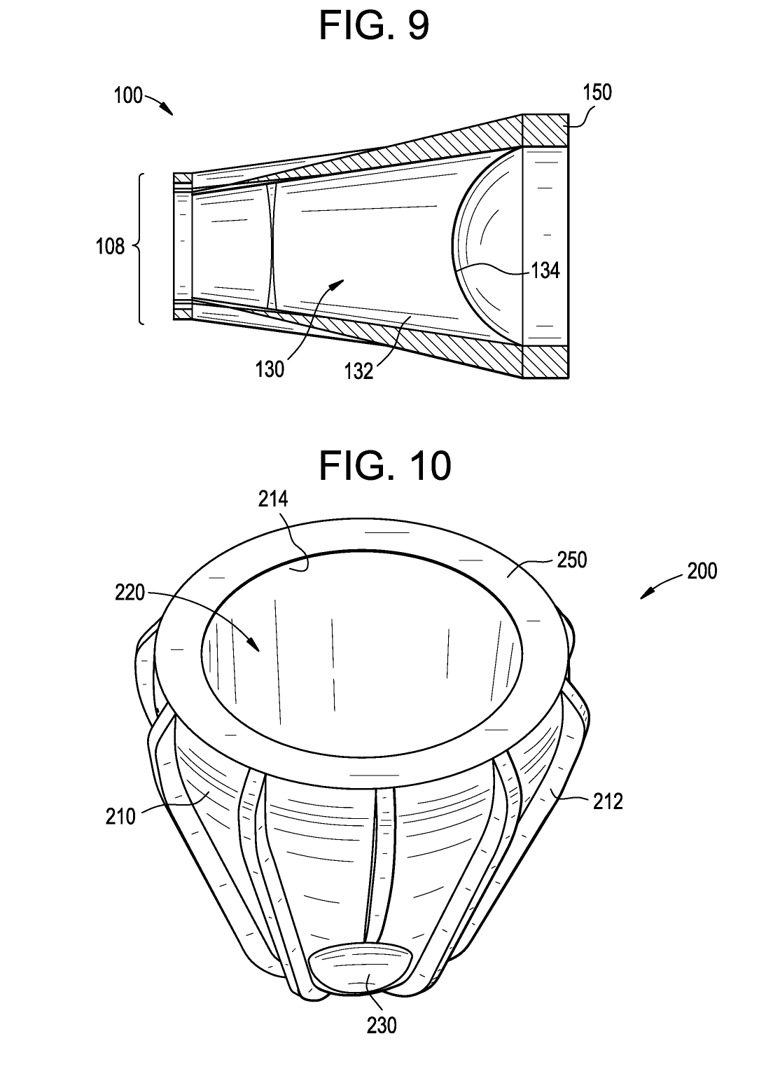

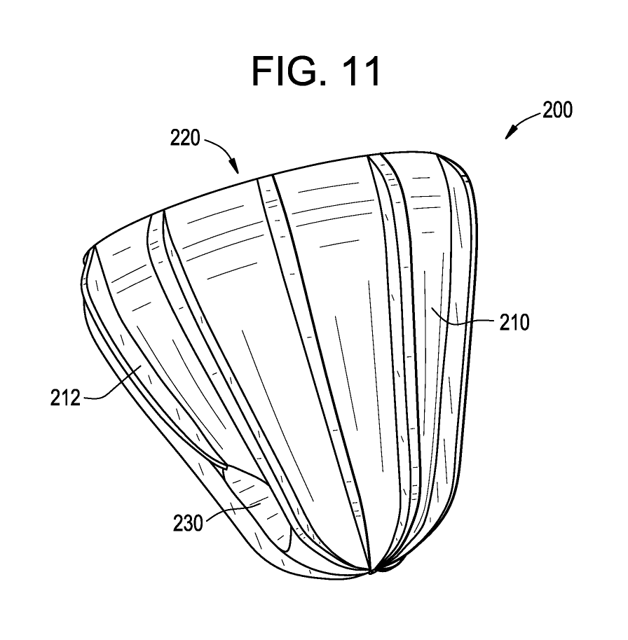

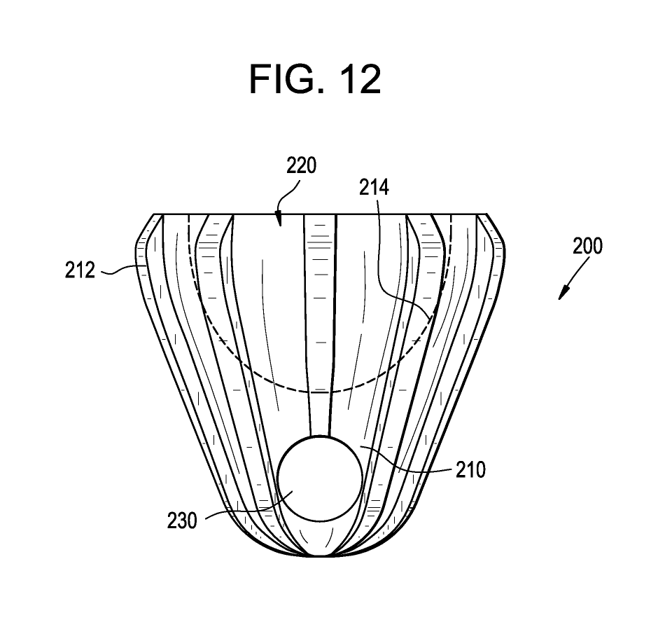

FIG. 6 is a cross-section of the exemplary U-bend fitting 10 of FIG. 1 shown fused to the wall 21 of a first pipe 11 having a first pipe outer diameter (D1) and the wall 22 of a second pipe 12 having a second pipe outer diameter (D2), wherein the first pipe 11 extends parallel to the second pipe 12. FIG. 6 shows the flow path chamber 100 welded to the flow transition chamber 200 (e.g., using butt fusion) forming a fusion bead 30 at the location of the fusion. FIGS. 8 and 9 show the flow transition chamber interface 150 which is the surface of the flow path chamber 100 used to weld to the flow path chamber interface 250 of the flow transition chamber 200 (FIG. 10). FIGS. 7-9 are perspective and cross-section views of the flow path chamber 100 of the exemplary U-bend fitting 10 of FIG. 1. FIGS. 10-12 are perspective and side views of the flow transition chamber 200 of the exemplary U-bend fitting 10 of FIG. 1.

As shown in FIGS. 6-9, in one embodiment, the flow path chamber comprises a housing 140 extending longitudinally from a first end 101 of the flow path chamber 100 to a second end 102 of the flow path chamber 100. A flow path chamber pipe interface 108 is used to connect the first pipe 11 and the second pipe 12 to the flow path chamber 100. The flow path chamber pipe interface 108 includes a first pipe interface 112 located at the first end 101 of the flow path chamber 102 for connecting the first pipe 11 to the flow path chamber 100 and a second pipe interface 122 located at the first end 101 of the flow path chamber 100 for connecting the second pipe 12 to the flow path chamber 100. In one exemplary embodiment, the wall 21 of the first pipe 11 is fused (e.g., using butt fusion) to the first pipe interface 112, while the wall 22 of the second pipe 12 is fused to the second pipe interface 122 of the flow path chamber 100.

As shown in the embodiment depicted in FIGS. 6-9, the first pipe interface 112 and the second pipe interface 122 are circular. In addition, the first pipe interface 112 adjoins the second pipe interface 122 as the two circular interfaces 112, 122 are externally tangential. Given this compact configuration of the flow path chamber pipe interface 108, the maximum outer diameter (D3) of the flow path chamber 100 (an in particular the flow path chamber pipe interface 108 (FIGS. 6-9)) is substantially equal to the maximum combined outer diameter of the pipes 11, 12 when the pipes 11, 12 are pressed together as shown in FIG. 6 (e.g., the sum of the first pipe outer diameter (D1) and the second pipe outer diameter (D2)).

Using the example of two 1.25 in. (31.75 mm) diameter pipes, each having an outer diameter (D1, D2) of 1.66 in. (42.16 mm), the maximum combined outer diameter is 3.32 in. (84.32 mm). Accordingly, the flow path chamber pipe interface 108 used to interface to those pipes would have a maximum outer diameter (D3) substantially equal to 3.32 in. (84.32 mm) (e.g., no more than 5.0 percent greater than the maximum combined outer diameter of the two pipes 11, 12 pressed together).

Returning to FIGS. 6-9, the exemplary flow path chamber 100 includes a divider wall 130 disposed within the housing 140. The divider wall 130 extends transversally across the inside of the housing 140 and extends longitudinally from a first end 131 at a location between the first pipe interface 112 and the second pipe interface 122 to a second end 132 toward the second end 102 of the flow path chamber 100. As seen in FIG. 8, the divider wall 140 extends transversally across the inside of the housing 140, diametrically from a first portion of the inner surface 144 of the housing 140 to a second portion of the inner surface 144 of the housing 140.

The divider wall 140 divides the flow path chamber 100 into a first flow path 110 extending longitudinally through the flow path chamber 100 from the first pipe interface 112 and a second flow path 120 extending longitudinally through the flow path chamber 100 from the second pipe interface 122. For example, the first flow path 110 can be the supply path and the second flow path 120 can be the return flow path in a flow system. In one embodiment and as shown in FIG. 6, the wall 142 of the housing tapers from the first end 101 of the flow path chamber 100 having a first thickness to the second end 102 of the flow path chamber 100 having a second thickness, wherein the first thickness is less than the second housing thickness. This slight taper facilitates flow without greatly reducing the flow area in the U-bend fitting 10.

As can be seen in FIGS, 6, 8, and 9, the second end 132 of the divider wall 140 does not extend completely to the second end 102 of the flow path chamber 100. This increases the size of the flow transition path 240 between the first flow path 110 and the second flow path 120. In one embodiment and as best shown in FIGS. 6, 8, and 9, the second end 132 of the divider wall 130 is curved 134 away from the flow transition chamber 200 to increase the size of the flow transition path 240 between the first flow path 110 and the second flow path 120. In that way, the portions of the second end 132 of the divider wall 130 that contact the inner surface 144 of the housing 140 are closer to the flow transition chamber 200 than a center portion of the second end of the divider wall 130.

As shown in the exemplary embodiment of the flow transition chamber 200 of FIGS. 10-12, the flow transition chamber 200 includes a cap 210 connected to and enclosing the second end 102 of the flow path chamber 100. A hemispherical cavity 220 (e.g., circular, ovular, elliptical, etc.) is formed on the inner surface 214 of the cap 210 to provide a flow transition path 240 between the first flow path 110 and the second flow path 120 of the flow path chamber 100. In one embodiment, the flow transition chamber 200 includes ribs 212 on the outer surface of the cap 210 and an aperture 230 for facilitating entry and movement into a borehole.

The larger flow area (e.g., 7.5 sq. in (48.387 sq. cm.)) provided by the U-bend fitting 10 without any sharp turns can provide a smaller pressure drop than a conventional U-bend fitting, requiring less pumping power and resulting in energy savings. Also, the larger flow area can decrease the risk that debris that inadvertently enters the ground loops of the heat pump system can block the flow.

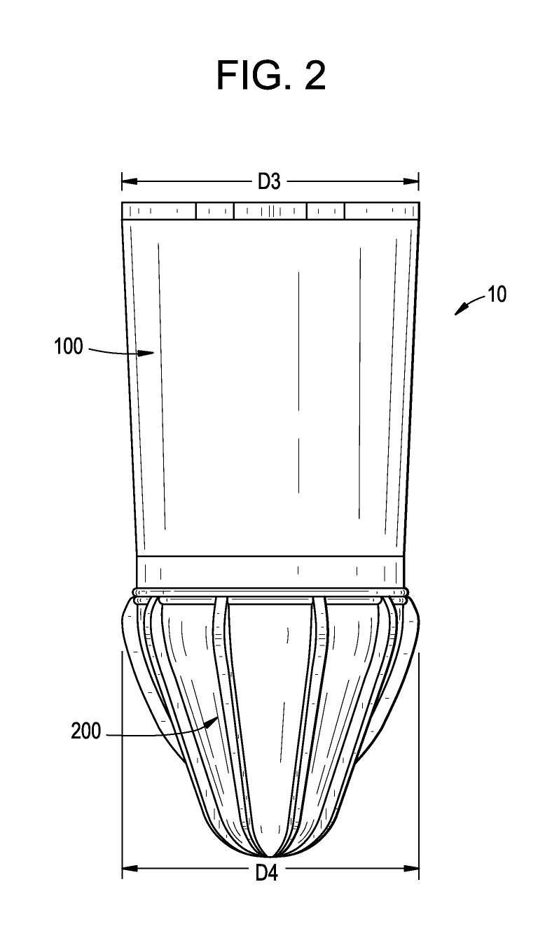

As discussed previously, given the compact configuration of the flow path chamber pipe interface 108, the maximum outer diameter (D3) of the flow path chamber 100 (an in particular the flow path chamber pipe interface 108 (FIGS. 6-9)) is substantially equal to the maximum combined outer diameter of the pipes 11, 12 when the pipes 11, 12 are pressed together as shown in FIG. 6. As shown in FIGS. 2, 4 and 5, the maximum outer diameter of the flow transition chamber 200 (and in particular the cap 210 (FIGS. 10-12)) is less than or substantially equal to the maximum outer diameter of the flow path chamber 100. Accordingly, the maximum diameter of the U-bend fitting (D3 or D4) is substantially equal to the maximum combined outer diameter of the pipes 11, 12 when the pipes 11, 12 are pressed together.

An advantage that may be realized in the practice of some disclosed embodiments of the U-bend fitting 10 is that the diameter of the borehole can match and need not be much larger than the maximum combined outer diameters (D1, D2) of the pipes 11,12, resulting in a less expensive and easier to construct smaller diameter borehole than used with a conventional U-bend fitting. Since smaller diameter boreholes usually take less time to drill, this decreases labor costs. In addition, since boreholes are typically hundreds of feet in length, the significant reduction or elimination of the empty space from the surface to the bottom of the borehole that exists between the pipes themselves and between the pipes and the walls of the borehole, reduces the amount of thermally enhanced grout and sand needed to backfill, decreasing costs and labor. These smaller diameter boreholes also decrease the costs of transportation to remove the reduced amount of material excavated from the borehole. Given the compact size of the U-bend fitting, larger diameter pipes (e.g., 1.5 in. (38.1 mm), 2.0 in. (50.8 mm), etc.) can be used without unreasonably larger boreholes.

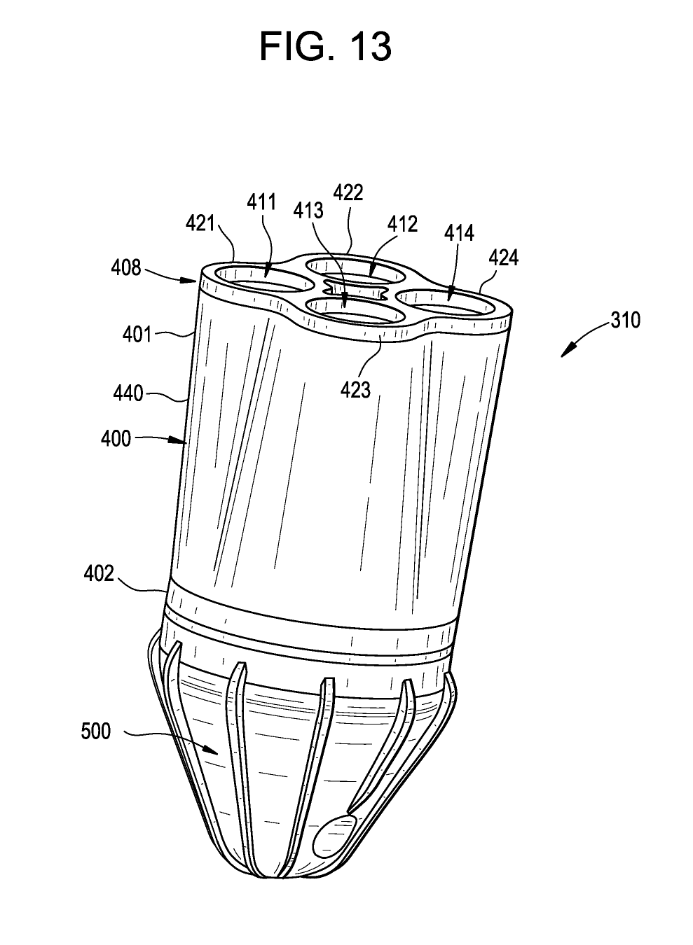

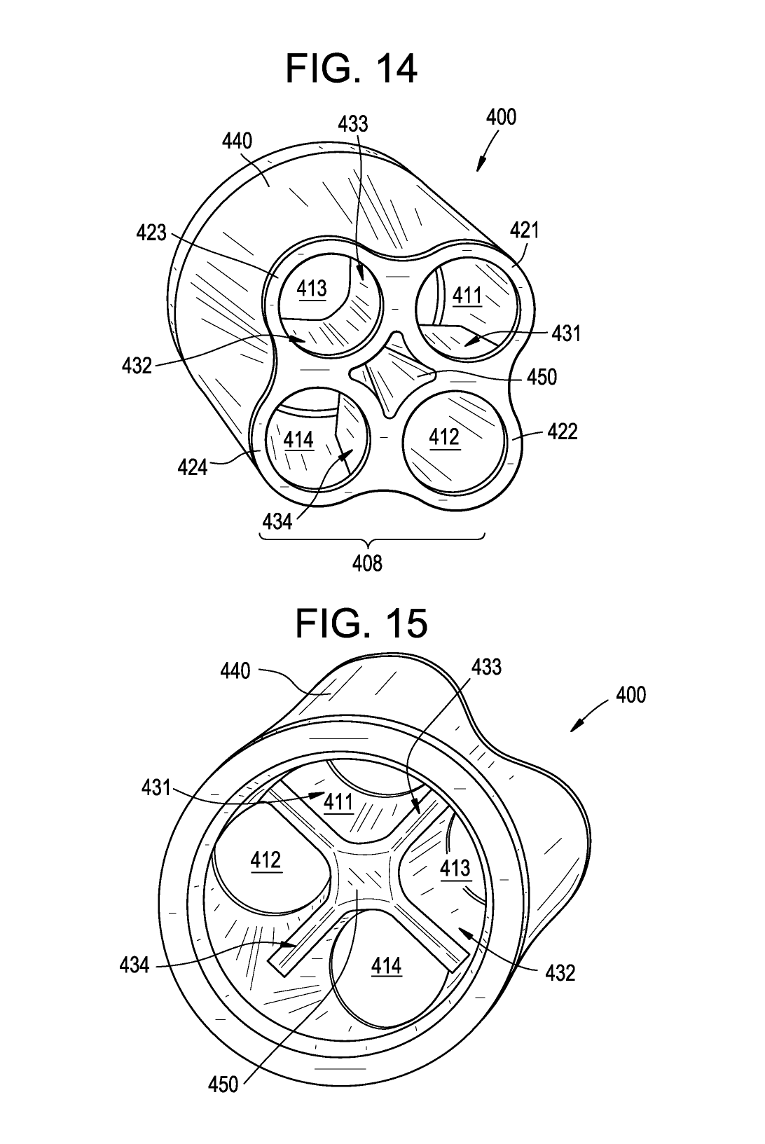

FIG. 13 is a perspective view of an exemplary U-bend fitting 300 for four pipes extending parallel to each other. Although the exemplary embodiment shown in FIGS. 1-12 depicts a U-bend fitting 10 suitable for connecting two pipes (e.g. a supply pipe and a return pipe), it will be understood that, as shown in FIG. 13, a U-bend fitting 310 can be provided for more than two pipes. The four-pipe U-bend fitting 310 operates similarly to the two-pipe U-Bend fitting 10 described previously. FIGS. 14 and 15 are perspective top and bottom views of the flow path chamber 400 of the exemplary U-bend fitting 310 of FIG. 13.

The U-bend fitting 310 includes a flow path chamber 400 that includes a housing 440 extending longitudinally from a first end 401 of the flow path chamber 400 to a second end 402 of the flow path chamber 400. A flow path chamber pipe interface 408 includes a first pipe interface 421 for connecting the first pipe to the flow path chamber 400, a second pipe interface 422 for connecting the second pipe to the flow path chamber 400, a third pipe interface 423 for connecting the third pipe to the flow path chamber 400, and a fourth pipe interface 424 for connecting the fourth pipe to the flow path chamber 400.

As shown in the embodiment depicted in FIGS. 13-15, the pipe interfaces 421, 422, 423, 424 are circular. In addition, each pipe interface adjoins two other pipe interfaces as the circular interfaces are externally tangential. Given this compact configuration of the flow path chamber pipe interface 408, the maximum outer diameter of the flow path chamber 400 (an in particular the flow path chamber pipe interface 408) is substantially equal to the maximum combined outer diameter of the pipes when the four pipes are pressed together. As shown in FIGS. 13-15, the maximum outer diameter of the flow transition chamber 500 (and in particular the cap (FIGS. 10-12)) is less than or substantially equal to the maximum outer diameter of the flow path chamber 400. Accordingly, the maximum diameter of the U-bend fitting 310 is substantially equal to the maximum combined outer diameter of the pipes when the four pipes are pressed together.

A first divider wall 431 extends transversally across the inside of the housing 440 and extends longitudinally from a first end at a location between the first pipe interface 421 and the second pipe interface 422 to a second end toward the second end of the flow path chamber 400. A second divider wall 432 extends transversally across the inside of the housing 440 and extends longitudinally from a first end at a location between the third pipe interface 423 and the fourth pipe interface 424 to a second end toward the second end 402 of the flow path chamber 400. A third divider wall 433 extends transversally across the inside of the housing 408 and extends longitudinally from a first end at a location between first pipe interface 421 and the third pipe interface 423 to a second end toward the second end 402 of the flow path chamber 400. A fourth divider wall 434 extends transversally across the inside of the housing 440 and extends longitudinally from a first end at a location between the second pipe interface 422 and the fourth pipe interface 424 to a second end toward the second end 402 of the flow path chamber 400. In one embodiment, each of the divider walls 431, 432, 433, and 434 can extend from the housing 440 to a central hub 450 located in the flow path chamber 400.

The divider walls 431, 432, 433, 444 divide the flow path chamber 400 into a first flow path 411 extending longitudinally through the flow path chamber 400 from the first pipe interface 421, a second flow path 412 extending longitudinally through the flow path chamber 400 from the second pipe interface 422, a third flow path 413 extending longitudinally through the flow path chamber 400 from the third pipe interface 423, and a fourth flow path 414 extending longitudinally through the flow path chamber 400 from the fourth pipe interface 424.

The flow transition chamber 500 of the four-pipe U-bend fitting 310 is designed in the same way as the two-pipe U-bend fitting 10 as shown in FIGS. 1-6 and 10-12. The flow transition chamber 500 includes a cap connected to and enclosing the second end 402 of the flow path chamber 400 A hemispherical cavity formed on the inner surface of the cap provides a flow transition path between the between the first flow path 411 and one or more of the second 412, third 413, and fourth 414 flow paths.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A U-bend fitting for connecting a first pipe having a first pipe outer diameter and a second pipe having a second pipe outer diameter, wherein the first pipe extends parallel to the second pipe, the U-bend fitting comprising:
a flow path chamber comprising
a housing extending longitudinally from a first end of the flow path chamber to a second end of the flow path chamber,
a flow path chamber pipe interface comprising a first pipe interface located at the first end of the flow path chamber for connecting the first pipe to the flow path chamber and a second pipe interface located at the first end of the flow path chamber for connecting the second pipe to the flow path chamber, and
a divider wall disposed within the housing, the divider wall extending transversally across the inside of the housing and extending longitudinally from a first end at a location between the first pipe interface and the second pipe interface to a second end toward the second end of the flow path chamber, wherein the divider wall divides the flow path chamber into a first flow path extending longitudinally through the flow path chamber from the first pipe interface and a second flow path extending longitudinally through the flow path chamber from the second pipe interface; and
a flow transition chamber comprising
a cap connected to and enclosing the second end of the flow path chamber, and
a hemispherical cavity formed on the inner surface of the cap to provide a flow transition path between the first flow path and the second flow path.

2. The U-bend fitting of claim 1, wherein the maximum outer diameter of the flow path chamber is substantially equal to the maximum combined outer diameter when the first pipe and the second pipe are pressed together.

3. The U-bend fitting of claim 2, wherein the maximum outer diameter of the flow transition chamber is less than or substantially equal to the maximum outer diameter of the flow path chamber.

4. The U-bend fitting of claim 1, wherein the first pipe interface adjoins the second pipe interface.

5. The U-bend fitting of claim 1, wherein the first pipe interface and the second pipe interface are circular.

6. The U-bend fitting of claim 5, wherein the first pipe interface and the second pipe interface are externally tangential.

7. The U-bend fitting of claim 1, wherein the second end of the divider wall does not extend completely to the second end of the flow path chamber to increase the size of the flow transition path between the first flow path and the second flow path.

8. The U-bend fitting of claim 1, wherein the second end of the divider wall is curved away from the flow transition chamber to increase the size of the flow transition path between the first flow path and the second flow path.

9. The U-bend fitting of claim 1, wherein the divider wall extending transversally across the inside of the housing extends diametrically from a first portion of the inner surface of the housing to a second portion of the inner surface of the housing.

10. The U-bend fitting of claim 9, wherein the portions of the second end of the divider wall that contact the first and second portions of the inner surface of the housing are closer to the flow transition chamber than a center portion of the second end of the divider wall.

11. The U-bend fitting of claim 1, wherein the wall of the housing tapers from the first end of the flow path chamber having a first thickness to the second end of the flow path chamber having a second thickness, wherein the first thickness is less than the second housing thickness.

12. The U-bend fitting of claim 1, wherein the flow transition chamber further comprises ribs on the outer surface of the cap.

13. The U-bend fitting of claim 1, wherein the flow path chamber is welded to the flow transition chamber using butt fusion.

14. A U-bend fitting for connecting a first pipe having a first pipe outer diameter, a second pipe having a second pipe outer diameter, a third pipe having a third pipe outer diameter, and a fourth pipe having a fourth pipe outer diameter, wherein the pipes extend parallel to each other, the U-bend fitting comprising:
a flow path chamber comprising
a housing extending longitudinally from a first end of the flow path chamber to a second end of the flow path chamber,
a flow path chamber pipe interface comprising a first pipe interface located at the first end of the flow path chamber for connecting the first pipe to the flow path chamber, a second pipe interface located at the first end of the flow path chamber for connecting the second pipe to the flow path chamber, a third pipe interface located at the first end of the flow path chamber for connecting the third pipe to the flow path chamber, and a fourth pipe interface located at the first end of the flow path chamber for connecting the fourth pipe to the flow path chamber,
a first divider wall disposed within the housing, the divider wall extending transversally across the inside of the housing and extending longitudinally from a first end at a location between the first pipe interface and the second pipe interface to a second end toward the second end of the flow path chamber,
a second divider wall disposed within the housing, the divider wall extending transversally across the inside of the housing and extending longitudinally from a first end at a location between the third pipe interface and the fourth pipe interface to a second end toward the second end of the flow path chamber,
a third divider wall disposed within the housing, the divider wall extending transversally across the inside of the housing and extending longitudinally from a first end at a location between first pipe interface and the third pipe interface to a second end toward the second end of the flow path chamber, and
a fourth divider wall disposed within the housing, the divider wall extending transversally across the inside of the housing and extending longitudinally from a first end at a location between the second pipe interface and the fourth pipe interface to a second end toward the second end of the flow path chamber,
wherein the divider walls divide the flow path chamber into a first flow path extending longitudinally through the flow path chamber from the first pipe interface, a second flow path extending longitudinally through the flow path chamber from the second pipe interface, a third flow path extending longitudinally through the flow path chamber from the third pipe interface, and a fourth flow path extending longitudinally through the flow path chamber from the fourth pipe interface; and
a flow transition chamber comprising
a cap connected to and enclosing the second end of the flow path chamber, and
a hemispherical cavity formed on the inner surface of the cap to provide a flow transition path between the first flow path and one or more of the second, third, and fourth flow paths.

15. The U-bend fitting of claim 14, wherein the maximum outer diameter of the flow path chamber is substantially equal to the maximum combined outer diameter when the first pipe, the second pipe, the third pipe, and the fourth pipe are pressed together.

16. The U-bend fitting of claim 15, wherein the maximum outer diameter of the flow transition chamber is less than or substantially equal to the maximum outer diameter of the flow path chamber.

17. A flow system comprising:
a first pipe having a first pipe outer diameter;
second pipe having a second pipe outer diameter, wherein the first pipe extends parallel to the second pipe;
a U-bend fitting for connecting the first pipe and a second pipe, the U-bend fitting comprising:
a flow path chamber comprising
a housing extending longitudinally from a first end of the flow path chamber to a second end of the flow path chamber,
a flow path chamber pipe interface comprising a first pipe interface located at the first end of the flow path chamber connected to the first pipe and a second pipe interface located at the first end of the flow path chamber connected to the second pipe, and
a divider wall disposed within the housing, the divider wall extending transversally across the inside of the housing and extending longitudinally from a first end at a location between the first pipe interface and the second pipe interface to a second end toward the second end of the flow path chamber, wherein the divider wall divides the flow path chamber into a first flow path extending longitudinally through the flow path chamber from the first pipe interface and a second flow path extending longitudinally through the flow path chamber from the second pipe interface; and
a flow transition chamber comprising
a cap connected to and enclosing the second end of the flow path chamber, and
a hemispherical cavity formed on the inner surface of the cap to provide a flow transition path between the first flow path and the second flow path.

18. The flow system of claim 17, wherein the maximum outer diameter of the flow path chamber is substantially equal to the maximum combined outer diameter when the first pipe and the second pipe are pressed together.

19. The flow system of claim 18, wherein the maximum outer diameter of the flow transition chamber is less than or substantially equal to the maximum outer diameter of the flow path chamber.

20. The flow system of claim 17, wherein the first pipe interface adjoins the second pipe interface.

21. The flow system of claim 17, wherein the first pipe interface and the second pipe interface are circular.

22. The flow system of claim 21, wherein the first pipe interface and the second pipe interface are externally tangential.

23. The flow system of claim 17, wherein the second end of the divider wall does not extend completely to the second end of the flow path chamber to increase the size of the flow transition path between the first flow path and the second flow path.

24. The flow system of claim 17, wherein the divider wall extending transversally across the inside of the housing extends diametrically from a first portion of the inner surface of the housing to a second portion of the inner surface of the housing.

25. The flow system of claim 17, wherein the wall of the housing tapers from the first end of the flow path chamber having a first thickness to the second end of the flow path chamber having a second thickness, wherein the first thickness is less than the second housing thickness.

26. The flow system of claim 17, wherein the flow path chamber pipe interface is welded to the first pipe and the second pipe using butt fusion.
